(19) United States
(12) Patent Application Publication
(10) Pub. No.: US 2018/0132633 A1
(43) Pub. Date: May 17, 2018

(54) Portable Adjustable Pillow

(71) Applicant: Donald Krsacok, Bedford, OH (US)

(72) Inventor: Donald Krsacok, Bedford, OH (US)

(21) Appl. No.: 15/351,612

(22) Filed: Nov. 15, 2016

(51) Int. Cl. A47G 9/10; A47C 7/38; B60N 2/48; A47C 7/62

(52) U.S. Cl. CPC A47G 9/10; A47C 7/383; A47C 7/62; B60N 2/4805; B60N 2/4879

(57) ABSTRACT

An adjustable pillow system for a user designed for mounting to a plurality of different seating devices, comprising: a pillow portion, designed to support a portion of a user when used therein, having at least two opposite sides; and an elastic portion, being shaped in a longitudinal length of material, and having opposite ends thereof and attached to the two opposite sides of the pillow portion. Wherein the pillow portion includes a pocket portion, mounted on at least one side of the pillow portion. Wherein, the pillow system includes a reservation card that is stored in the pocket portion, and is removable therefrom, to be placed on a seat when the user is not seated on a selected seat.

### CROSS REFERENCE TO RELATED APPLICATION

PCT/US16/61878, titled: Portable Adjustable Pillow, by Donald Krsacok, and filed Nov. 14, 2016.

### FEDERALLY SPONSORED RESEARCH AND DEVELOPMENT

Not Applicable

### MICROFICHE APPENDIX

Not Applicable

### BACKGROUND OF THE INVENTION

### (1) Field of the Invention

The invention disclosed herein generally relates to cushioning accessories. More particularly, the invention relates to a cushioning aid accessory such as a portable adjustable pillow convenient for any type of seating devices.

### (2) Background of the Invention

Generally, lightweight, portable, or casual seating devices, such as folding lawn chairs, deck chairs, and the like, were used along with cushioning materials such as pillows, headrest, etc. The pillows provide comfort to the user while using the seating or resting devices. However, the pillow occupies certain place in the user's seat, and further adds luggage to the user such as a trekker, or a tourist. Majority of the seating devices is in lack of any pillows since this type of seating device needing to be relatively simple, portable, lightweight, and to fold to a compact size. The seating device provides minimum comfort or convenience features, fails to attempt at padding or upholstery, and often not even having arm or head rests, in the case of most folding metal or leisure chairs.

Hence, there is a long felt but unresolved need for a for a removable, portable pillows for chairs such as lawn chairs, deck chairs, folding chairs and other lightweight and portable seating. While the present pillow is adapted to be particularly suitable for such seating device, and further it is also applicable to other types of seating devices as well.

From the subsequent description, the preferred embodiments of the present invention overcome the disadvantages of the prior art. In this regard, the present invention discloses a portable, adjustable pillow for releasable attachment to any type of seating or resting devices preferably vehicle such as car, bus or a lawn chairs, deck chairs, folding chairs, and other lightweight and portable seating.

### SUMMARY

In view of the foregoing disadvantages inherent in the known types of pillow to be adjustable or like in the prior art, the present invention provides an improved portable and adjustable pillow adaptive and convenient to different design of seating devices. As such, the general purpose of the present invention, which will be described subsequently in greater detail, is to provide a new and improved pillow with all the advantages of the prior art and none of the disadvantages.

Accordingly, it is a feature of the present invention to provide an adjustable pillow system for a user designed for mounting to a plurality of different seating devices, comprising: a pillow portion, designed to support a portion of a user when used therein, having at least two opposite sides; and an elastic portion, being shaped in a longitudinal length of material, and having opposite ends thereof and attached to the two opposite sides of the pillow portion. Wherein the pillow portion includes a pocket portion, mounted on at least one side of the pillow portion. Wherein, the pillow system includes a reservation card that is stored in the pocket portion, and is removable therefrom, to be placed on a seat when the user is not seated on a selected seat.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is perspective view in a side of the present invention.

FIG. 2 is another perspective view in another side of the present invention.

FIG. 3 is rear view of the present invention.

FIG. 4 is an exemplary application of the present invention in reserving a place.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

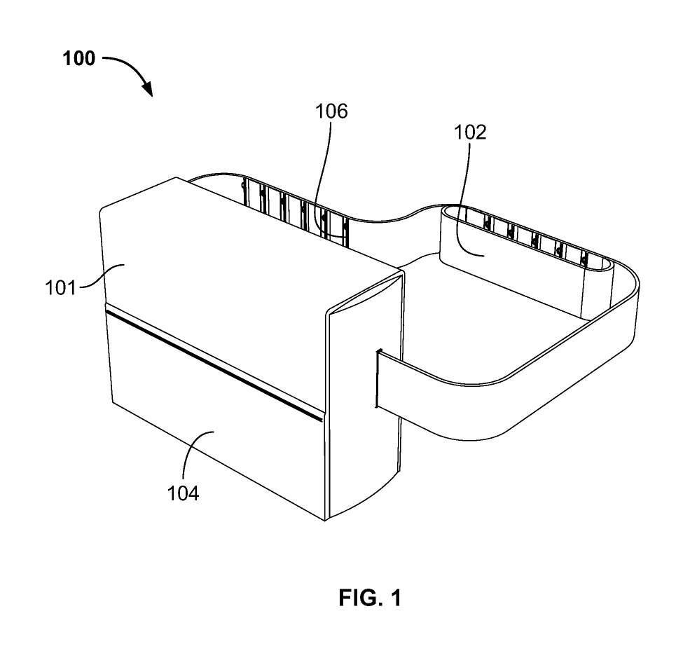

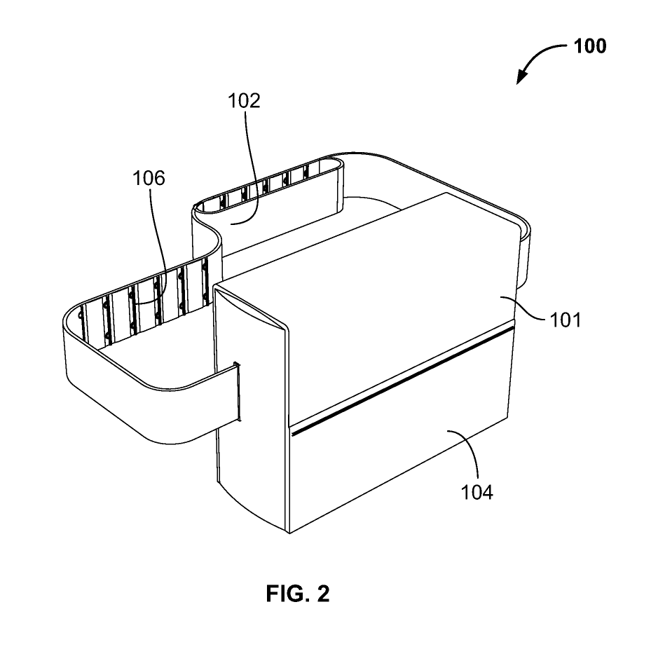

Turning now to FIG. 1 and FIG. 2, there is illustrated one embodiment of a portable and adjustable pillow system 100 adaptive and mountable onto different designs of seating devices. Specifically, there is an adjustable pillow system 100 designed to be mounted on a plurality of seating device. The pillow system 100 comprises an elastic portion 102 attached to at least two sides of a pillow portion 101, and a pillow portion 101. Wherein, the elastic portion 102 is attached to the right and the left sides of the pillow 101, and potentially includes an attachment system 106. The elastic portion 102 is extensible and retractable for receiving or holding a person's back support member of the seating devices (not shown). The elastic portion 102 could be extended or retracted based on the attachment system 106 to fit over all type of seating devices such, for example, as a chair, lounger, air craft seating, or restaurant seating. The elastic portion 102 could be substantially rectangular or square shaped structure. As illustrated, the elastic portion 102 of the portable and adjustable pillow system 100 could be in any shape thereon that can hold any seating devices forming an integral part therewith. Additionally, in one embodiment, there could be on the pillow portion 101 a pocket portion 104, designed to retain items, like gloves, hats, scarves, reserved cards, etc. The pocket portion 104 may be placed on any surface of the pillow portion 101, like the front, back, top, bottom, side, or on multiple surfaces in the case of multiple pockets 104. In another potential embodiment of the invention, there is an adjustment system 106, which is illustrated in the form of a hook and eye type coupling system. Whereby, the hooks on one side can be coupled to any number of eye positions as illustrated along the elastic strap 102.

It is noted that it should be obvious to one skilled in the art, the illustrated pillow portion 101 is made like any known pillow in the art, like having a cushioning section that may be covered by a material layer, or may not, depending upon the cushioning material that is selected. Additionally, in another embodiment, the pillow portion 101 could be a hollow bladder and is blown up by the user like a beach ball.

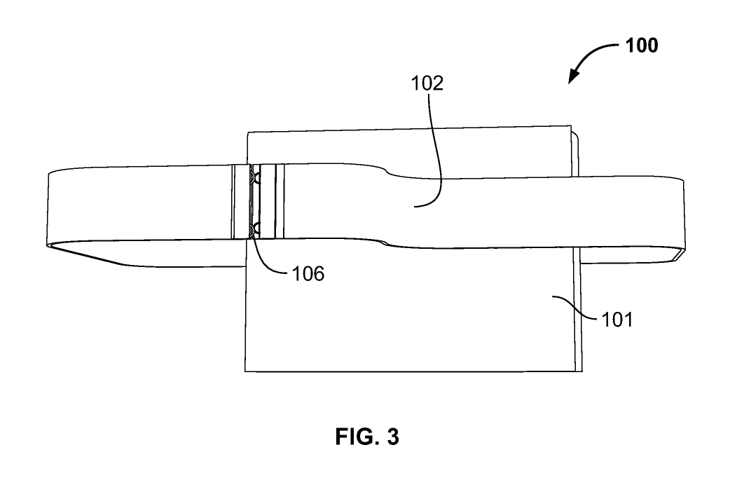

Turning now to FIG. 3, illustrates a rear view of the portable and adjustable pillow system 100, constituting elastic portion 102 attached to the pillow portion 101 on either sides. The elastic portion 102 of the portable and adjustable pillow system 100 could be secured on the backside of the airplane seat as a headrest. The adjustable pillow system 100 is a sanitize headrest for vehicles, which could be wiped off and sanitized easily. The elastic portion 102 is configured to wrap or strap the pillow portion 101 around a luggage of the user, while carrying on during travel or getting into a transportation, such as airplane, etc. The elastic portion 102 may also be configured to wrap or strap the pillow portion 101 around any supportive luggage, or body of the user.

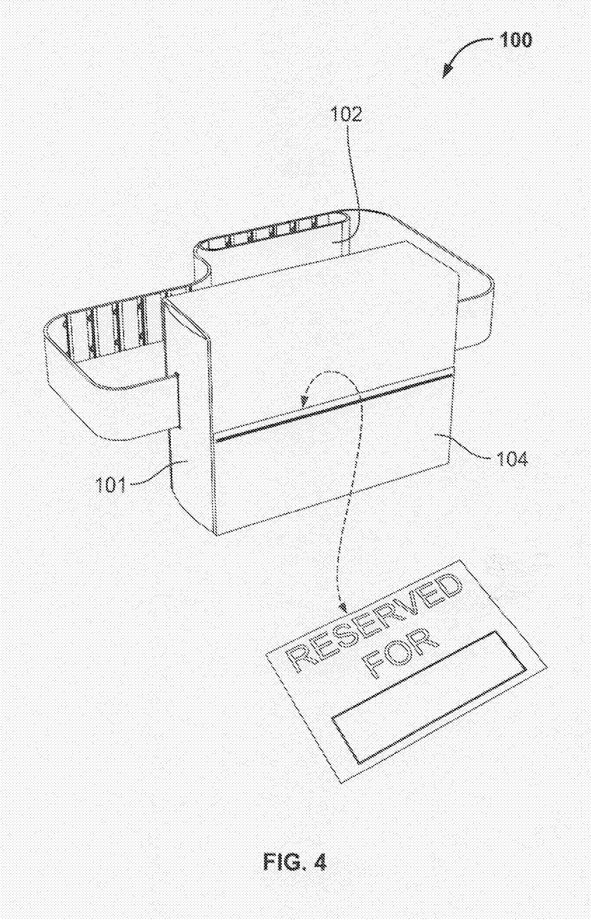

Turning now to FIG. 4, illustrates an exemplary application of the portable and adjustable pillow system 100 in reserving a place, for example, reservation of place in beach, etc. The adjustable pillow system 100 could be used on any beach chair or lounger to reserve the place for the user. Further, the elastic portion 102 attached to the pillow 101 is configured to hold a towel during windy days in a place or any particular chair or lounge. The adjustable pillow system 100 could be fitted to any kind of beach chairs or loungers.

The adjustable pillow system 100 is easily sanitized, which provides anti-microbial travel and home product for the user. The adjustable pillow system 100 could be used as a travel pillow, while using them in airplane, or swimming pool chair or lounge chair, in a hygienic way. The adjustable pillow system 100 is constructed with an elastic strap, which could be attached to an airplane seat, lounge, chair at poolside, etc., or anywhere where the user seeks for comforter by using a pillow. The adjustable pillow system 100 provides combined convenience along with cleanliness, health and safety with an anti-microbial feature, and reserving a place using the same.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

1-6. (canceled)

7. (canceled)

8. A pillow designed for placement on a seating device to enable a user to indicate a saved seat, consisting essentially of:
a) a pillow, with a rectangular shape to support a back of a user when sitting on the seating device, having a front and back side opposite to each other, and a right and left connecting sections coupled to edges of the front and back sides respectively;
b) a single strap having opposite ends attached exactly horizontally to a middle portion of the front and back sides on the right and left connecting edge sections thereof;
c) a clear pocket, mounted to the front side of the pillow;
d) a reservation card that is removably stored in the clear pocket to enable viewability by others when the user is not seated on the seating device; and
e) an adjustment system, coupled on the single strap, to adjust a length thereof.
